(19) United States
(12) Patent Application Publication
(10) Pub. No.: US 2014/0192687 A1
(43) Pub. Date: Jul. 10, 2014

(54) METHOD AND APPARATUS FOR TRANSMITTING UPLINK CONTROL INFORMATION IN A WIRELESS COMMUNICATION SYSTEM

(71) Applicants: Dongcheol Kim, Anyang-si (KR); Hangyu Cho, Anyang-si (KR); Jinmin Kim, Anyang-si (KR); Hyunwoo Lee, Anyang-si (KR)

(72) Inventors: Dongcheol Kim, Anyang-si (KR); Hangyu Cho, Anyang-si (KR); Jinmin Kim, Anyang-si (KR); Hyunwoo Lee, Anyang-si (KR)

(73) Assignee: LG ELECTRONICS INC., Seoul (KR)

(21) Appl. No.: 14/234,363

(22) PCT Filed: Jul. 23, 2012
(86) PCT No.: PCT/KR2012/005872

§ 371 Date: Jan. 22, 2014

Related U.S. Application Data
(60) Provisional application No. 61/510,499, filed on Jul. 22, 2011.

(51) Int. Cl. H04L 5/14; H04L 5/00

(52) U.S. Cl. CPC H04L 5/14; H04L 5/0032
USPC 370/280

(57) ABSTRACT

Disclosed are a method and apparatus for transmitting uplink control information in a wireless communication system. A method for transmitting uplink control information by a terminal in a wireless communication system may comprise the steps of: receiving, from a base station, information on a primary cell (Pcell) and at least one secondary cell (Scell) configured for said terminal; and transmitting the uplink control information through the specific Scell configured for said terminal when said Pcell and said Scell are set to different time division duplex (TDD) downlink (DL)/uplink (UL) configurations and said terminal is set to simultaneously transmit a physical uplink control channel (PUCCH) and a physical uplink shared channel (PUSCH).

### TECHNICAL FIELD

The present invention relates to wireless communication, and more particularly, to a method and apparatus for transmitting uplink control information in a wireless communication system.

### BACKGROUND ART

A 3^{rd} generation partnership project long term evolution (3GPP LTE) (hereinafter, referred to as ‘LTE’), LTE-Advanced (hereinafter, referred to as ‘LTE-A) communication system which is an example of a mobile communication system to which the present invention can be applied will be described in brief.

FIG. 1 is a diagram illustrating a network structure of an Evolved Universal Mobile Telecommunications System (E-UMTS) which is an example of a mobile communication system.

The E-UMTS is an evolved version of the conventional UMTS, and its basic standardization is in progress under the 3rd Generation Partnership Project (3GPP). The E-UMTS may also be referred to as a Long Term Evolution (LTE) system. For details of the technical specifications of the UMTS and E-UMTS, refer to Release 7 and Release 8 of “3rd Generation Partnership Project; Technical Specification Group Radio Access Network”.

Referring to FIG. 1, the E-UMTS includes a User Equipment (UE), base stations (eNode B and eNB), and an Access Gateway (AG) which is located at an end of a network (E-UTRAN) and connected to an external network. The base stations may simultaneously transmit multiple data streams for a broadcast service, a multicast service and/or a unicast service.

One or more cells may exist for one base station. One cell is set to one of bandwidths of 1.25, 2.5, 5, 10, and 20 MHz to provide a downlink or uplink transport service to several user equipments. Different cells may be set to provide different bandwidths. Also, one base station controls data transmission and reception for a plurality of user equipments. The base station transmits downlink (DL) scheduling information of downlink data to the corresponding user equipment to notify the corresponding user equipment of time and frequency domains to which data will be transmitted and information related to encoding, data size, and hybrid automatic repeat and request (HARQ). Also, the base station transmits uplink (UL) scheduling information of uplink data to the corresponding user equipment to notify the corresponding user equipment of time and frequency domains that can be used by the corresponding user equipment, and information related to encoding, data size, and HARQ. An interface for transmitting user traffic or control traffic can be used between the base stations. An interface for transmitting user traffic or control traffic may be used between the base stations. A Core Network (CN) may include the AG and a network node or the like for user registration of the user equipment UE. The AG manages mobility of the user equipment UE on a Tracking Area (TA) basis, wherein one TA includes a plurality of cells.

Although the wireless communication technology developed based on WCDMA has been evolved into LTE, request and expectation of users and providers have continued to increase. Also, since another wireless access technology is being continuously developed, new evolution of the wireless communication technology will be required for competitiveness in the future. In this respect, reduction of cost per bit, increase of available service, use of adaptable frequency band, simple structure, open type interface, proper power consumption of the user equipment, etc. are required.

Recently, standardization of the advanced technology of the LTE is in progress under the 3rd Generation Partnership Project (3GPP). In this specification, the advanced technology will be referred to as ‘LTE-A’. One of the important differences between the LTE system and the LTE-A system is the difference in system bandwidth and introduction of a relay station.

The LTE-A system aims to support a broad bandwidth of maximum 100 MHz. To this end, the LTE-A system uses the carrier aggregation technology or the bandwidth aggregation technology, which achieves a broad bandwidth by using a plurality of frequency blocks.

The carrier aggregation uses a plurality of frequency blocks as one large logic frequency bandwidth to use a wider frequency bandwidth. A bandwidth of each frequency block may be defined on the basis of a bandwidth of a system block used in the LTE system. Each frequency block is transmitted using a component carrier.

### DISCLOSURE

### Technical Problem

An object of the present invention devised to solve the conventional problem is to provide a method for enabling a user equipment to transmit uplink control information in a wireless communication system.

Another object of the present invention devised to solve the conventional problem is to provide a user equipment for transmitting uplink control information in a wireless communication system.

It will be appreciated by persons skilled in the art that the objects that could be achieved with the present invention are not limited to what has been particularly described hereinabove and the above and other objects that the present invention could achieve will be more clearly understood from the following detailed description.

### Technical Solution

To achieve these objects and other advantages and in accordance with the purpose of the invention, a method for transmitting uplink control information by a user equipment in a wireless communication system comprises the steps of receiving, from a base station, information on a primary cell (Pcell) and at least one secondary cell (Scell) configured for the user equipment; and transmitting the uplink control information through a specific Scell configured for the user equipment when the Pcell and the Scell have their respective time division duplex (TDD) downlink (DL)/uplink (UL) configurations different from each other and the user equipment is configured to simultaneously transmit a physical uplink control channel (PUCCH) and a physical uplink shared channel (PUSCH).

The uplink control information may be at least one of hybrid automatic repeat request (HARQ) feedback information, periodic channel state information (CSI) reporting information, channel quality information (CQI), precoding matrix index (PMI) information, rank indicator (RI) information, or scheduling request (SR) information. The HARQ feedback information may be for a physical downlink shared channel (PDSCH) of the specific Scell configured for the user equipment. An interval to which the uplink control information is transmitted is allocated as a downlink subframe for the Pcell and as an uplink subframe for the specific Scell configured for the user equipment. The specific Scell is any one Scell allocated to the interval to which the uplink control information will be transmitted, as the uplink subframe interval, if a plurality of Scells are configured for the user equipment. The specific cell is the Scell to which the PUSCH is transmitted together with the uplink control information when a plurality of Scells are configured for the user equipment and the uplink subframe interval for all of the plurality of the Scells is allocated to the interval to which the uplink control information will be transmitted.

In another aspect, to achieve these objects and other advantages and in accordance with the purpose of the invention, a user equipment for transmitting uplink control information in a wireless communication system comprises a receiver configured to receive, from a base station, information on a primary cell (Pcell) and at least one secondary cell (Scell) configured for the user equipment; a processor configured to perform a control operation to transmit the uplink control information through a specific Scell configured for the user equipment when the Pcell and the Scell have their respective time division duplex (TDD) downlink (DL)/uplink (UL) configurations different from each other and the user equipment is set to simultaneously transmit a physical uplink control channel (PUCCH) and a physical uplink shared channel (PUSCH); and a transmitter configured to transmit the uplink control information through the specific Scell configured for the user equipment.

### Advantageous Effects

According to the embodiment of the present invention, transmission timing delay of control information (for example, HARQ feedback), which may occur when respective cells have their respective TDD DL/UL configurations different from each other, may be avoided, whereby communication throughput may be improved.

It will be appreciated by persons skilled in the art that that the effects that could be achieved with the present invention are not limited to what has been particularly described hereinabove and other advantages of the present invention will be more clearly understood from the following detailed description.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a diagram illustrating a network structure of an Evolved Universal Mobile Telecommunications System (E-UMTS) which is an example of a mobile communication system;

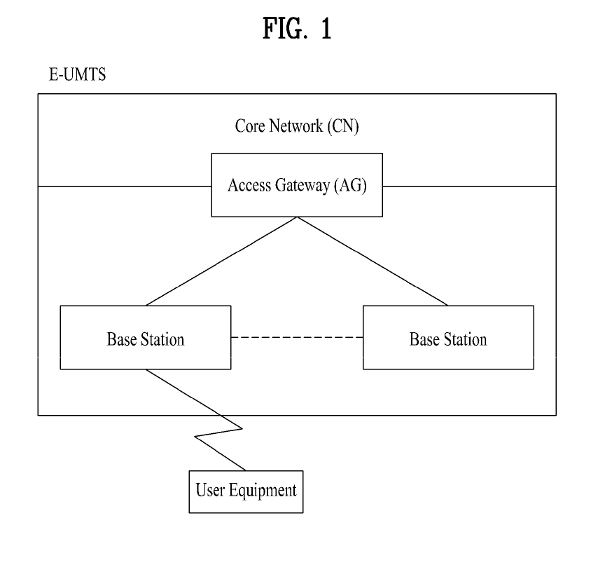

FIG. 2 is a block diagram illustrating configurations of a base station 205 and a mobile station 210 in a wireless communication system 200;

FIG. 3 is a diagram illustrating a structure of a radio frame used in a 3GPP LTE/LTE-A system which is an example of a wireless communication system;

FIG. 4 is a diagram illustrating a resource grid of a downlink slot of a 3GPP LTE/LTE-A system which is an example of a wireless communication system;

FIG. 5 is a diagram illustrating a structure of a downlink subframe of a 3GPP LTE/LTE-A system which is an example of a wireless communication system;

FIG. 6 is a diagram illustrating a structure of an uplink subframe of a 3GPP LTE/LTE-A system which is an example of a wireless communication system; and

FIG. 7 is a diagram illustrating a carrier aggregation (CA) communication system.

### BEST MODE FOR CARRYING OUT THE INVENTION

Hereinafter, the preferred embodiments of the present invention will be described in detail with reference to the accompanying drawings. It is to be understood that the detailed description, which will be disclosed along with the accompanying drawings, is intended to describe the exemplary embodiments of the present invention, and is not intended to describe a unique embodiment with which the present invention can be carried out. The following detailed description includes detailed matters to provide full understanding of the present invention. However, it will be apparent to those skilled in the art that the present invention can be carried out without the detailed matters. For example, although the following description will be made based on the assumption that the mobile communication system is the 3GPP LTE or LTE-A system, the following description may be applied to other mobile communication systems except for particular matters of the 3GPP LTE or LTE-A system.

In some cases, to prevent the concept of the present invention from being ambiguous, structures and apparatuses of the known art will be omitted, or will be shown in the form of a block diagram based on main functions of each structure and apparatus. Also, wherever possible, the same reference numbers will be used throughout the drawings and the specification to refer to the same or like parts.

Moreover, in the following description, it is assumed that a user equipment (UE) refers to a mobile or fixed type user equipment such as a mobile station (MS) and an advanced mobile station (AMS). Also, it is assumed that the base station refers to a random node of a network terminal, such as Node B, eNode B, and access point (AP), which performs communication with the user equipment.

In a wireless communication system, a user equipment may receive information from a base station through a downlink (DL), and may also transmit information to the base station through an uplink. Examples of information transmitted from and received by the user equipment include data and various kinds of control information. Various physical channels exist depending on types and usage of information transmitted from or received by the user equipment.

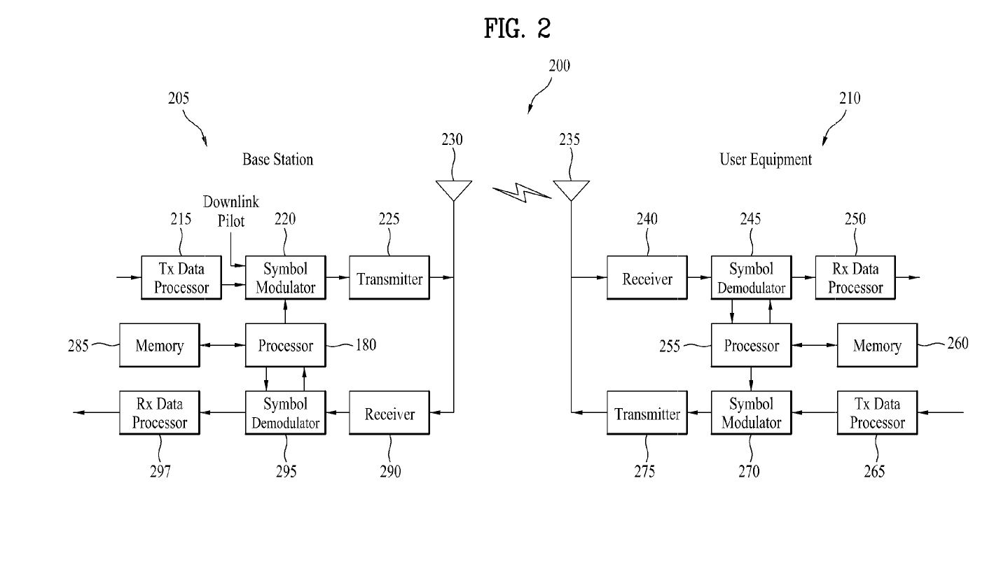

FIG. 2 is a block diagram illustrating configurations of a base station 205 and a user equipment 210 in a wireless communication system 200.

Although one base station 205 and one user equipment 210 are shown for simplification of a wireless communication system 200, the wireless communication system 200 may include one or more base stations and/or one or more mobile user equipments.

Referring to FIG. 21, the base station 205 may include a transmitting (Tx) data processor 215, a symbol modulator 220, a transmitter 225, a transmitting and receiving antenna 230, a processor 280, a memory 285, a receiver 290, a symbol demodulator 295, and a receiving (Rx) data processor 297. The user equipment 210 may include a Tx data processor 265, a symbol modulator 270, a transmitter 275, a transmitting and receiving antenna 235, a processor 255, a memory 260, a receiver 240, a symbol demodulator 255, and an Rx data processor 250. Although the antennas 230 and 235 are respectively shown in the base station 205 and the user equipment 210, each of the base station 205 and the user equipment 210 includes a plurality of antennas. Accordingly, the base station 205 and the user equipment 210 according to the present invention support a multiple input multiple output (MIMO) system. Also, the base station 205 according to the present invention may support both a single user-MIMO (SU-MIMO) system and a multi user-MIMO (MU-MIMO) system.

On a downlink, the Tx data processor 215 receives traffic data, formats and codes the received traffic data, interleaves and modulates (or symbol maps) the coded traffic data, and provides the modulated symbols (“data symbols”). The symbol modulator 220 receives and processes the data symbols and pilot symbols and provides streams of the symbols.

The symbol modulator 220 multiplexes the data and pilot symbols and transmits the multiplexed data and pilot symbols to the transmitter 225. At this time, the respective transmitted symbols may be a signal value of null, the data symbols and the pilot symbols. In each symbol period, the pilot symbols may be transmitted continuously. The pilot symbols may be frequency division multiplexing (FDM) symbols, orthogonal frequency division multiplexing (OFDM) symbols, time division multiplexing (TDM) symbols, or code division multiplexing (CDM) symbols.

The transmitter 225 receives the streams of the symbols and converts the received streams into one or more analog symbols. Also, the transmitter 225 generates downlink signals suitable for transmission through a radio channel by additionally controlling (for example, amplifying, filtering and frequency upconverting) the analog signals. Subsequently, the antenna 230 transmits the generated downlink signals to the user equipment 210.

In the configuration of the user equipment 210, the antenna 235 receives the downlink signals from the base station 205 and provides the received signals to the receiver 240. The receiver 240 controls (for example, filters, amplifies and frequency downcoverts) the received signals and digitalizes the controlled signals to acquire samples. The symbol demodulator 245 demodulates the received pilot symbols and provides the demodulated pilot symbols to the processor 255 to perform channel estimation.

Also, the symbol demodulator 245 receives a frequency response estimation value for the downlink from the processor 255, acquires data symbol estimation values (estimation values of the transmitted data symbols) by performing data demodulation for the received data symbols, and provides the data symbol estimation values to the Rx data processor 250. The Rx data processor 250 demodulates (i.e., symbol de-mapping), deinterleaves, and decodes the data symbol estimation values to recover the transmitted traffic data.

Processing based on the symbol demodulator 245 and the Rx data processor 250 is complementary to processing based on the symbol demodulator 220 and the Tx data processor 215 at the base station 205.

On an uplink, the Tx data processor 265 of the user equipment 210 processes traffic data and provides data symbols. The symbol modulator 270 receives the data symbols, multiplexes the received data symbols with the pilot symbols, performs modulation for the multiplexed symbols, and provides the streams of the symbols to the transmitter 275. The transmitter 275 receives and processes the streams of the symbols and generates uplink signals. The antenna 235 transmits the generated uplink signals to the base station 205.

The uplink signals are received in the base station 205 from the user equipment 210 through the antenna 230, and the receiver 290 processes the received uplink signals to acquire samples. Subsequently, the symbol demodulator 295 processes the samples and provides data symbol estimation values and the pilot symbols received for the uplink. The Rx data processor 297 recovers the traffic data transmitted from the user equipment 210 by processing the data symbol estimation values.

The processors 255 and 280 of the user equipment 210 and the base station 205 respectively command (for example, control, adjust, manage, etc.) the operation at the user equipment 210 and the base station 205. The processors 255 and 280 may respectively be connected with the memories 260 and 285 that store program codes and data. The memories 260 and 285 respectively connected to the processor 280 store operating system, application, and general files therein.

Each of the processors 255 and 280 may be referred to as a controller, a microcontroller, a microprocessor, and a microcomputer. Meanwhile, the processors 255 and 280 may be implemented by hardware, firmware, software, or their combination. If the embodiment of the present invention is implemented by hardware, application specific integrated circuits (ASICs), digital signal processors (DSPs), digital signal processing devices (DSPDs), programmable logic devices (PLDs), and field programmable gate arrays (FPGAs) configured to perform the embodiment of the present invention may be provided in the processors 255 and 280.

Meanwhile, if the embodiment according to the present invention is implemented by firmware or software, firmware or software may be configured to include a module, a procedure, or a function, which performs functions or operations of the present invention. Firmware or software configured to perform the present invention may be provided in the processors 255 and 280, or may be stored in the memories 260 and 285 and driven by the processors 255 and 280.

Layers of a radio interface protocol between the user equipment 210 or the base station 205 and a wireless communication system (network) may be classified into a first layer L1, a second layer L2 and a third layer L3 on the basis of three lower layers of OSI (open system interconnection) standard model widely known in communication systems. A physical layer belongs to the first layer L1 and provides an information transfer service using a physical channel. A radio resource control (RRC) layer belongs to the third layer and provides control radio resources between the user equipment and the network. The user equipment and the base station may exchange RRC messages with each another through the RRC layer.

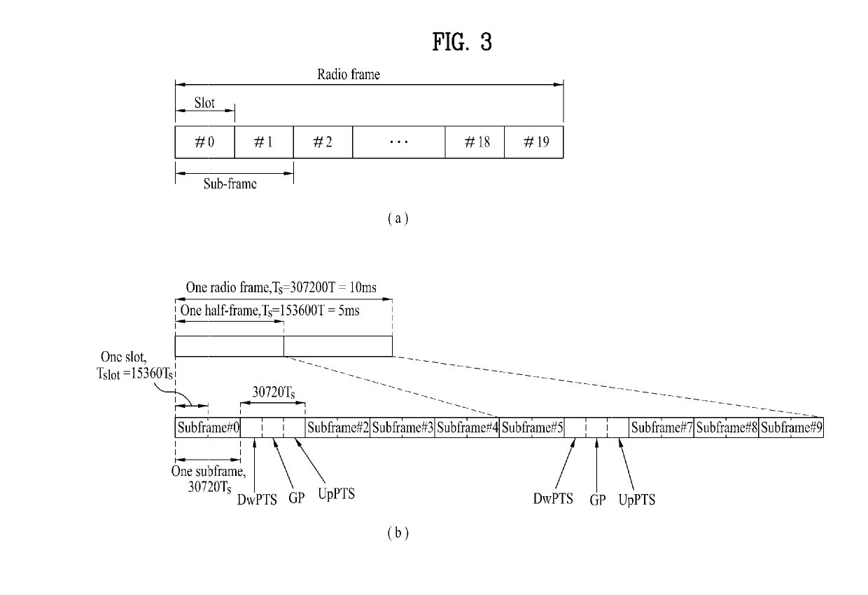

FIG. 3 is a diagram illustrating a structure of a radio frame in a 3GPP LTE/LTE-A system, which is an example of a wireless communication system.

In a cellular OFDM wireless packet communication system, uplink/downlink data packet transmission is performed in a subframe unit, wherein one subframe is defined by a given time interval that includes a plurality of OFDM symbols. The 3GPP LTE standard supports a type 1 radio frame structure applicable to frequency division duplex (FDD) and a type 2 radio frame structure applicable to time division duplex (TDD).

FIG. 3(a) is a diagram illustrating a structure of a type 1 radio frame. The downlink radio frame includes 10 subframes, each of which includes two slots in a time domain. A time required to transmit one subframe will be referred to as a transmission time interval (TTI). For example, one subframe may have a length of 1 ms, and one slot may have a length of 0.5 ms. One slot includes a plurality of OFDM symbols in a time domain and a plurality of resource blocks (RB) in a frequency domain. Since OFDMA is used on a downlink in the 3GPP LTE system, OFDM symbols represent one symbol interval. The OFDM symbols may be referred to as SC-FDMA symbols or symbol interval. The resource block as resource allocation unit may include a plurality of continuous subcarriers in one slot.

The number of OFDM symbols included in one slot may be varied depending on configuration of cyclic prefix (CP). Examples of the CP include extended CP and normal CP. For example, if the OFDM symbols are configured by normal CP, the number of OFDM symbols included in one slot may be 7. If the OFDM symbols are configured by extended CP, since the length of one OFDM symbol is increased, the number of OFDM symbols included in one slot is smaller than that of OFDM symbols in case of normal CP. In case of the extended CP, the number of OFDM symbols included in one slot may be 6. If a channel status is unstable like the case where the user equipment moves at high speed, the extended CP may be used to reduce inter-symbol interference.

If the normal CP is used, since one slot includes seven OFDM symbols, one subframe includes 14 OFDM symbols. At this time, first two or three OFDM symbols of each subframe may be allocated to a physical downlink control channel (PDCCH), and the other OFDM symbols may be allocated to a physical downlink shared channel (PDSCH).

FIG. 3(b) is a diagram illustrating a structure of a type 2 radio frame. The type 2 radio frame includes two half frames, each of which includes five subframes, a downlink pilot time slot (DwPTS), a guard period (GP), and an uplink pilot time slot (UpPTS). One of the five subframes includes two slots. The DwPTS is used for initial cell search, synchronization or channel estimation at the user equipment. The UpPTS is used to synchronize channel estimation at the base station with uplink transmission of the user equipment. Also, the guard period is to remove interference occurring in the uplink due to multipath delay of downlink signals between the uplink and the downlink.

Each half frame includes five subframes, in which the subframe “D” is for downlink transmission, the subframe “U” is for uplink transmission, the subframe “S” is a special subframe that includes a downlink pilot time slot (DwPTS), a guard period (GP), and an uplink pilot time slot (UpPTS). The DwPTS is used for initial cell search, synchronization or channel estimation at the user equipment. UpPTS is used to synchronize uplink transmission of the user equipment and channel estimation at the base station. Also, the guard period is to remove interference occurring in the uplink due to multipath delay of downlink signals between the uplink and the downlink.

In case of 5 ms downlink-uplink switch-point period, the special subframe S exists per half-frame. In case of 5 ms downlink-uplink switch-point period, the special subframe S exists at the first half-frame only. Subframe indexes 0 and 5 (subframe 0 and 5) and DwPTS are for downlink transmission only. The subframe subsequent to the UpPTS and the special subframe is always for uplink transmission. If multi-cells are aggregated, the user equipment may assume the same uplink-downlink configuration for all the cells, and the guard periods of the special frames at different cells are overlapped for at least 1456 Ts. The aforementioned structure of the radio frame is only exemplary, and various modifications may be made in the number of subframes included in the radio frame or the number of slots included in the subframe, or the number of symbols included in the slot.

The following Table 1 illustrates a configuration of the special subframe (length of DwPTS/GP/UpPTS).

TABLE 1

| | Normal cyclic prefix in downlink | | | | | |
|---|---|---|---|---|---|---|
| | | UpPTS | | Extended cyclic prefix in downlink | | |
| | | Normal | Extended | | UpPTS | |
| Special subframe | | cyclic prefix | cyclic prefix | | Normal cyclic | Extended cyclic |
| configuration | DwPTS | in uplink | in uplink | DwPTS | prefix in uplink | prefix in uplink |
| 0 | 6592 · Tₛ | 2192 · Tₛ | 2560 · Tₛ | 7680 · Tₛ | 2192 · Tₛ | 2560 · Tₛ |
| 1 | 19760 · Tₛ | | | 20480 · Tₛ | | |
| 2 | 21952 · Tₛ | | | 23040 · Tₛ | | |
| 3 | 24144 · Tₛ | | | 25600 · Tₛ | | |
| 4 | 26336 · Tₛ | | | 7680 · Tₛ | 4384 · Tₛ | 5120 · Tₛ |
| 5 | 6592 · Tₛ | 4384 · Tₛ | 5120 · Tₛ | 20480 · Tₛ | | |
| 6 | 19760 · Tₛ | | | 23040 · Tₛ | | |
| 7 | 21952 · Tₛ | | | — | — | — |
| 8 | 24144 · Tₛ | | | — | — | — |

The following Table 2 illustrates uplink-downlink configuration.

TABLE 2

| Uplink- | Downlink- | | | | | | | | | | |
|---|---|---|---|---|---|---|---|---|---|---|---|
| downlink | to-Uplink | | | | | | | | | | |
| config- | Switch-point | Subframe number | | | | | | | | | |
| uration | periodicity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |

Referring to Table 2, in the 3GPP LTE system, the type 2 frame structure includes seven types of uplink-downlink configurations. The number or position of downlink subframes, special subframes and uplink subframes may be varied per configuration. Hereinafter, various embodiments of the present invention will be described based on the uplink-downlink configuration of the type 2 frame structure illustrated in Table 2.

The aforementioned structure of the radio frame is only exemplary, and various modifications may be made in the number of subframes included in the radio frame, the number of slots included in the subframe, or the number of symbols included in the slot.

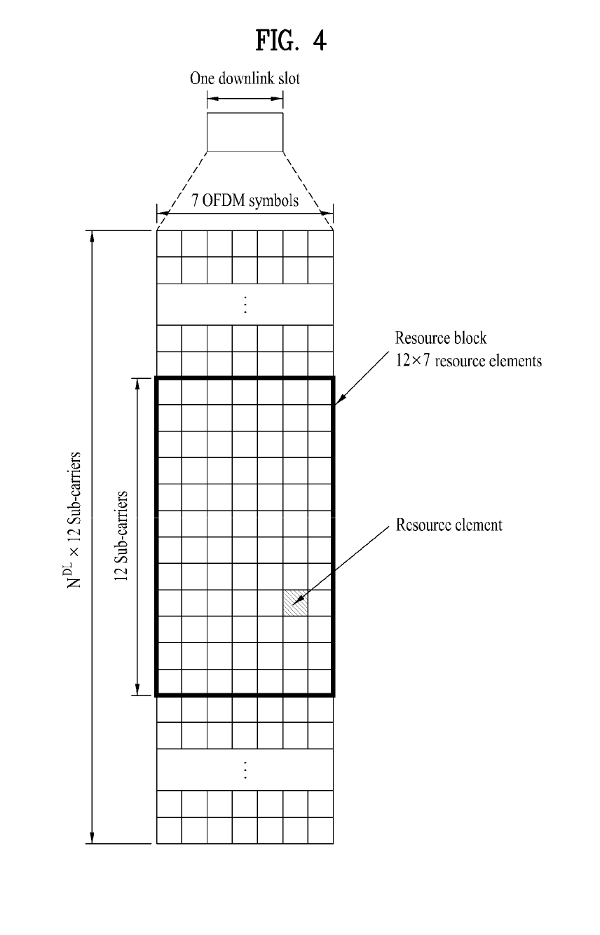

FIG. 4 is a diagram illustrating a resource grid of a downlink slot in a 3GPP LTE/LTE-A system, which is an example of a wireless communication system.

Referring to FIG. 4, the downlink slot includes a plurality of OFDM symbols in a time domain. One downlink slot includes seven(six) OFDM symbols, and a resource block includes twelve subcarriers in a frequency domain. Each element on the resource grid will be referred to as a resource element (RE). One resource block (RB) includes 12×7(6) resource elements. The number N_{RB} of resource blocks (RBs) included in the downlink slot depends on a downlink transmission bandwidth. A structure of an uplink slot may be the same as that of the downlink slot, wherein OFDM symbols are replaced with SC-FDMA symbols.

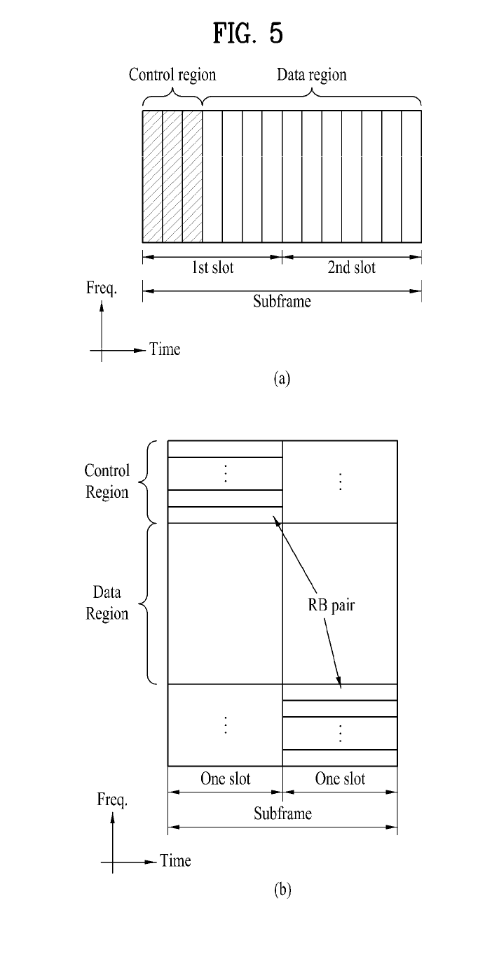

FIG. 5 is a diagram illustrating a structure of a downlink subframe in a 3GPP LTE/LTE-A system, which is an example of a wireless communication system.

Referring to FIG. 5, maximum three OFDM symbols located at the front of the first slot of the subframe correspond to a control region to which control channels are allocated. The other OFDM symbols correspond to a data region to which a physical downlink shared channel (PDSCH) is allocated. Examples of the downlink control channel used in the 3GPP LTE include a PCFICH (Physical Control Format Indicator CHannel), a PDCCH (Physical Downlink Control CHannel), and a PHICH (Physical Hybrid ARQ Indicator CHannel). The PCFICH is transmitted at the first OFDM symbol of the subframe, and carries information on the number (that is, the size of the control region) of OFDM symbols used for transmission of the control channel within the subframe. The PHICH is a response channel to the uplink, and carries ACK/NACK (acknowledgement/negative-acknowledgement) signal for HARQ (hybrid automatic repeat request).

The control information transmitted through the PDCCH will be referred to as downlink control information (DCI). The DCI includes format 0 defined for an uplink and formats 1, 1A, 1B, 1C, 1D, 2, 2A, 3, and 3A defined for a downlink. The DCI format selectively includes information such as a hopping flag, RB allocation, modulation coding scheme (MCS), redundancy version (RV), new data indicator (NDI), transmit power control (TPC), cyclic shift demodulation reference signal (DMRS), channel quality information (CQI) request, HARQ process number, transmitted precoding matrix indicator (TPMI), and precoding matrix indicator (PMI) confirmation in accordance with usage.

The PDCCH carries transport format and resource allocation information of a downlink shared channel (DL-SCH), transport format and resource allocation information of an uplink shared channel (UL-SCH), paging information on a paging channel (PCH), system information on the DL-SCH, resource allocation information of upper layer control message such as random access response transmitted on the PDSCH, a set of transmission (Tx) power control commands of individual user equipments (UEs) within a random user equipment group, Tx power control information, and activity information of voice over Internet protocol (VoIP). A plurality of PDCCHs may be transmitted within the control region. The user equipment may monitor the plurality of PDCCHs. The PDCCH is transmitted on aggregation of one or a plurality of continuous control channel elements (CCEs). The CCE is a logic allocation unit used to provide a coding rate based on the status of a radio channel to the PDCCH. The CCE corresponds to a plurality of resource element groups (REGs). The format of the PDCCH and the number of bits of the PDCCH are determined depending on the number of CCEs. The base station determines a PDCCH format depending on the DCI to be transmitted to the user equipment, and attaches cyclic redundancy check (CRC) to the control information. The CRC is masked (or scrambled) with an identifier (for example, radio network temporary identifier (RNTI)) depending on usage of the PDCCH or owner of the PDCCH. For example, if the PDCCH is for a specific user equipment, the CRC may be masked with an identifier (for example, cell-RNTI (C-RNTI)) of the corresponding user equipment. If the PDCCH is for a paging message, the CRC may be masked with a paging identifier (for example, Paging-RNTI (P-RNTI)). If the PDCCH is for system information (in more detail, system information block (SIB)), the CRC may be masked with system information RNTI (SI-RNTI). If the PDCCH is for a random access response, the CRC may be masked with a random access RNTI (RA-RNTI).

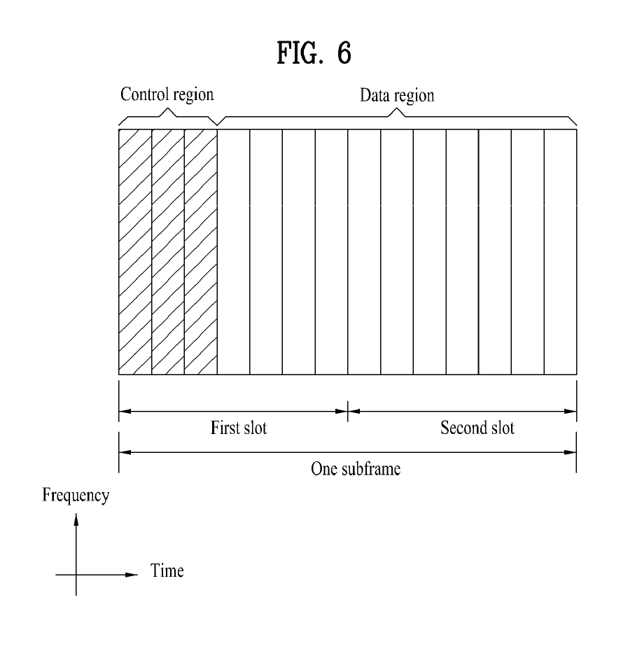

FIG. 6 is a diagram illustrating a structure of an uplink subframe in an LTE system in a 3GPP LTE/LTE-A system, which is an example of a wireless communication system.

Referring to FIG. 6, the uplink subframe includes a plurality of slots (for example, two). Each slot may include a plurality of SC-FDMA symbols, wherein the number of SC-FDMA symbols included in each slot is varied depending on a cyclic prefix (CP) length. The uplink subframe is divided into a data region and a control region in a frequency domain. The data region includes a PUSCH, and is used to transmit a data signal such as voice. The control region includes a PUCCH, and is used to transmit uplink control information (UCI). The PUCCH includes RB pair located at both ends of the data region on a frequency axis, and performs hopping on the border of the slots.

The PUCCH may be used to transmit the following control information.
SR (Scheduling Request): is information used to request uplink UL-SCH resource. The SR is transmitted using an on-off keying (OOK) system.
HARQ ACK/NACK: is a response signal to a downlink data packet on the PDSCH. It represents whether the downlink data packet has been successfully received. ACK/NACK 1 bit is transmitted in response to a single downlink codeword (CW), and ACK/NACK 2 bits are transmitted in response to two downlink codewords.
CQI (Channel Quality Information): is feedback information on a downlink channel. The MIMO (Multiple Input Multiple Output) related feedback information includes a rank indicator (RI), a precoding matrix indicator (PMI), and a precoding type indicator (PTI). 20 bits are used per subframe.

The quantity of the uplink control information (UCI) that may be transmitted from the user equipment for the subframe depends on the number of SC-FDMA symbols available for control information transmission. The SC-FDMA symbols available for control information transmission mean the remaining SC-FDMA symbols except for SC-FDMA symbols for reference signal transmission for the subframe, and the last SC-FDMA symbol of the subframe is excluded in case of the subframe for which a sounding reference signal (SRS) is set. The reference signal is used for coherent detection of the PUCCH. The PUCCH supports seven formats in accordance with information which is transmitted.

Table 3 illustrates a mapping relation between the PUCCH format and the UCI in the LTE system.

TABLE 3

| PUCCH format | Uplink control information (UCI) |
|---|---|
| Format 1 | SR (Scheduling Request) (non-modulated waveform) |
| Format 1a | 1-bit HARQ ACK/NACK with/without SR |
| Format 1b | 2-bit HARQ ACK/NACK with/without SR |
| Format 2 | CQI (20 coded bits) |
| Format 2 | CQI and 1- or 2-bit HARQ ACK/NACK (20 bits) for |
| | extended CP only |
| Format 2a | CQI and 1-bit HARQ ACK/NACK (20 + 1 coded bits) |
| Format 2b | CQI and 2-bit HARQ ACK/NACK (20 + 2 coded bits) |

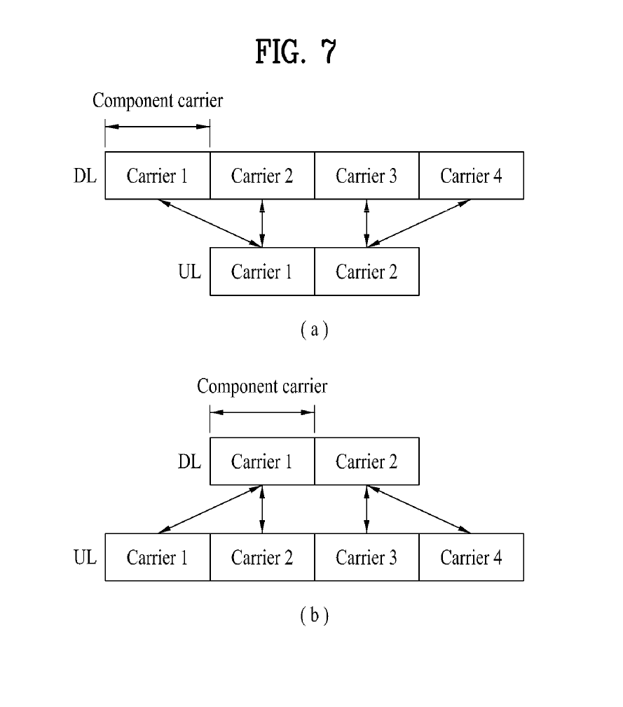

FIG. 7 is a diagram illustrating a carrier aggregation (CA) communication system.

The LTE-A system uses the carrier aggregation technology or the bandwidth aggregation technology, which uses greater uplink/downlink bandwidth through a plurality of uplink/downlink frequency blocks, to use wider frequency bandwidth. Each small frequency bandwidth is transmitted using a component carrier (CC). The component carrier may be understood as carrier frequency (or center carrier or center frequency) for a corresponding frequency block.

The respective CCs may adjoin each other or not in the frequency domain. A bandwidth of the CC may be limited to a bandwidth used in the existing system to maintain backward compatibility with the existing system. For example, the existing 3GPP LTE system supports bandwidths of {1.4, 3, 5, 10, 15, 20} MHz, and the 3GPP LTE-A system may support a bandwidth greater than 20 MHz using the above bandwidths supported by the LTE system. A bandwidth of each component carrier may be defined independently. Asymmetric carrier aggregation where the number of UL CCs is different from the number of DL CCs may be performed. DL CC/UL CC links may be fixed to the system or may be configured semi-statically. For example, if the number of DL CCs is 4 and the number of UL CCs is 2 as shown in FIG. 6(a), DL-UL linkage may be configured to correspond to correspond to DL CC:UL CC=2:1. Similarly, if the number of DL CCs is 2 and the number of UL CCs is 4 as shown in FIG. 6(b), DL-UL linkage may be configured to correspond to correspond to DL CC:UL CC=1:2. Unlike the shown case, symmetric carrier aggregation where the number of UL CCs is the same as the number of DL CCs may be performed. In this case, DL-UL linkage of DL CC:UL CC=1:1 may be configured.

Also, even though a system full bandwidth includes N number of CCs, a frequency bandwidth that may be monitored and received by a specific user equipment may be limited to M(<N) number of CCs. Various parameters for carrier aggregation may be configured cell-specifically, UE group-specifically, or UE-specifically. Meanwhile, the control information may be set to be transmitted and received through a specific CC only. This specific CC may be referred to as a primary CC (PCC), and the other CCs may be referred to as secondary CCs (SCC).

The LTE-A system uses a concept of a cell to manage radio resources. The cell is defined by combination of downlink resources and uplink resources, wherein the uplink resources may be defined selectively. Accordingly, the cell may be configured by downlink resources only, or may be configured by downlink resources and uplink resources. If carrier aggregation is supported, linkage between carrier frequency (or DL CC) of the downlink resources and carrier frequency (or UL CC) of the uplink resources may be indicated by system information. The cell operated on the primary frequency (or PCC) may be referred to as a primary cell (PCell), and the cell operated on the secondary frequency (or SCC) may be referred to as a secondary cell (SCell).

The PCell is used such that the user equipment performs an initial connection establishment procedure or connection re-establishment procedure. The PCell may refer to a cell indicated during a handover procedure. The SCell may be configured after RRC connection is established, and may be used to provide an additional radio resource. The PCell and the SCell may be referred to as serving cells. Accordingly, although the user equipment is in RRC-CONNECTED state, if it is not set by carrier aggregation or does not support carrier aggregation, a single serving cell configured by the P cell only exists. On the other hand, if the user equipment is in the RRC-CONNECTED state and is set by carrier aggregation, one or more serving cells may exist, wherein the serving cells may include the PCell and full SCells. After an initial security activation procedure starts, for the user equipment supporting carrier aggregation, the network may configure one or more SCells in addition to the PCell initially configured during a connection establishment procedure.

Unlike the existing LTE system that uses one carrier, a method for effectively controlling a plurality of component carriers in carrier aggregation that uses the plurality of component carriers has been required. In order to efficiently control the component carriers, the component carriers may be classified in accordance with their functions and features. In carrier aggregation, multiple carriers may be divided into a primary component carrier (PCC) and secondary component carrier (SCC). The component carriers may be UE-specific parameters.

The primary component carrier PCC is the component carrier that becomes a core for control of several component carriers when the component carriers are used, and is defined for each user equipment. The primary component carrier PCC may serve as a core carrier that controls the full component carriers, and the other secondary component carriers may serve to provide additional frequency resources for high transmission rate. For example, connection (RRC) for signaling between the base station and the user equipment may be performed through the primary component carrier. Information for security and upper layer may also be provided through the primary component carrier. Actually, if only one component carrier exists, the corresponding component carrier will be the primary component carrier. At this time, the component carrier may perform the same function as that of the carrier of the existing LTE system.

The base station may allocate an activated component carrier (ACC) of the plurality of component carriers to the user equipment. The user equipment previously knows the activated component carrier (ACC) allocated thereto through signaling. The user equipment may transmit responses to the plurality of PDCCHs, which are received from the downlink PCell and the downlink SCells, to the PUCCH through the uplink PCell.

The base station may configure the primary cell (PCell) configured for the user equipment and at least one or more secondary cells (SCells). The base station may transmit such PCell and SCell configuration information to the user equipment through upper layer signaling.

According to the related art, considering the system that one base station sets and uses a plurality of cells, timing and method for information transmission have been considered under the condition that TDD DL/UL configurations of respective cells are the same as each other. In the 3GPP LTE-A Rel-10, the PUCCH and the PUSCH may be transmitted from one cell at the same time. The user equipment generally transmits control information to the base station through the PUCCH. The PCell may be regarded as the cell where the user equipment has performed initial network entry. The other cells are added on the basis of the PCell. If there is no PUCCH and exists only a PUSCH, the user equipment transmits the uplink control information (UCI) together with the PUSCH.

Next, a method for HARQ-ACK channel transmission in the 3GPP LTE-A Release-10 will be described.

Method 1: In the 3GPP LTE-A Rel-10, simultaneous transmission of the PUCCH and the PUSCH is enabled or disabled, and if the PUSCH is not transmitted, HARQ-ACK channel is transmitted through the PUCCH.

Method 2: Simultaneous transmission of the PUCCH and the PUSCH is disabled, and if at least one PUSCH is transmitted, HARQ-ACK channel may be transmitted through the PUSCH.

The method for HARQ-ACK channel transmission is operated only if a plurality of cells use the same TDD DL/UL configuration. However, if separate TDD DL/UL configuration is used for each of the PCell and the SCells, a problem may occur in uplink information transmission in case of the method 1 for HARQ-ACK channel transmission.

The following Table 4 illustrates downlink related set indexes (K: (K₀, K₁, . . . , K_{M-2})).

TABLE 4

| UL-DL | Subframe n | | | | | | | | | |
|---|---|---|---|---|---|---|---|---|---|---|
| Configuration | 0 | 1 | 2 | 3 | 4 | 5 | 6 | 7 | 8 | 9 |
| 0 | — | — | 6 | — | 4 | — | — | 6 | — | 4 |
| 1 | — | — | 7, 6 | 4 | — | — | — | 7, 6 | 4 | — |
| 2 | — | — | 8, 7, 4, 6 | — | — | — | — | 8, 7, 4, 6 | — | — |
| 3 | — | — | 7, 6, 11 | 6, 5 | 5, 4 | — | — | — | — | — |
| 4 | — | — | 12, 8, 7, 11 | 6, 5, 4, 7 | — | — | — | — | — | — |
| 5 | — | — | 13, 12, 9, 8, 7, 5, 4, 11, 6 | — | — | — | — | — | — | — |
| 6 | — | — | 7 | 7 | 5 | — | — | 7 | 7 | — |

Referring Table 4, the number of HARQ feedbacks to be sent for the corresponding uplink subframe per TDD DL/UL configuration and subframe index information on the corresponding PDSCH may be identified.

The following Table 5 illustrates an example of TDD DL/UL configuration configured equally for two cells.

TABLE 5

| UL-DL | Subframe n | | | | | | | | | |
|---|---|---|---|---|---|---|---|---|---|---|
| Configuration | 0 | 1 | 2 | 3 | 4 | 5 | 6 | 7 | 8 | 9 |
| 0 | — | — | 6 | — | 4 | — | — | 6 | — | 4 |
| 0 | — | — | 6 | — | 4 | — | — | 6 | — | 4 |

Referring to Table 5, since TDD DL/UL configuration is configured equally for two cells, downlink transmission interval and uplink transmission interval are given for each cell at the same timing.

The following Table 6 illustrates an example of TDD DL/UL configuration configured differently for two cells.

TABLE 6

| UL-DL | Subframe n | | | | | | | | | |
|---|---|---|---|---|---|---|---|---|---|---|
| Configuration | 0 | 1 | 2 | 3 | 4 | 5 | 6 | 7 | 8 | 9 |
| 2 | D | S | 8, 7, | D | D | D | S | 8, 7, 4, 6 | D | D- |
| | | | 4, 6 | | | | | | | |
| 1 | D | S | 7, 6 | 4 | D | D | S | 7, 6 | 4 | D |

Referring to Table 6, if a separate TDD DL/UL configuration is configured for two cells, downlink transmission interval may be allocated to one cell in accordance with subframe index, and uplink transmission interval may be allocated to the other cell. In this case, there is a problem in application of the aforementioned method 1 for HARQ-ACK channel transmission in the 3GPP LTE-A Rel-10. Also, since the base station notifies the user equipment of simultaneous transmission of the PUCCH and the PUSCH through RRC signaling (for example, PUCCH Conf. information element), it is difficult to dynamically configure simultaneous transmission of the PUCCH and the PUSCH. Meanwhile, the aforementioned PUSCH is the PUSCH for new data transmission not retransmission, and a PUSCH which is for retransmission will be referred to as retransmission PUSCH.

Hereinafter, if a separate TDD DL/UL configuration is configured for each of the cells (PCell, SCell), a method for solving the problem in the method 1 for HARQ-ACK channel transmission will be suggested.

When simultaneous transmission of the PUCCH and the PUSCH is enabled, the PCell is configured by TDD DL/UL configuration 2 and the SCell is configured by TDD DL/UL configuration 1 as illustrated in Table 6. In this case, subframe indexes 3 and 8 become the downlink subframe interval in the PCell and become the uplink subframe index in the SCell. In this case, it is suggested that the user equipment transmits HARQ feedback information through the PUSCH of the SCell, whereby delay in transmission of the HARQ feedback information may be solved.

The base station may identify that HARQ feedback information transmitted to the PUSCH of the SCell is for the corresponding PDSCH of the SCell. This HARQ feedback information is based on the description disclosed in the 3GPP LTE-A TS 36.213. In this case, the user equipment may transmit related information such as control information (for example, periodic CSI (channel state information) reporting, CQI, PMI, RI, SR, etc.) in addition to the HARQ feedback information as above. For example, periodic CSI reporting is designed to be transmitted through the PUCCH only, whereby limited transmission occasion may be obtained. In case of Table 6, the user equipment may transmit periodic CSI reporting through the PUSCH of the SCell.

If a specific subframe index corresponds to the downlink subframe interval in the PCell and corresponds to the uplink subframe index in the other SCells, the user equipment selects the SCell to which the PUSCH is transmitted together with UCI in the 3GPP LTE Rel-10. Unlike this, if the specific subframe index corresponds to the uplink subframe interval in only one SCell, the user equipment performs transmission for the uplink subframe of the corresponding SCell.

Although it has been described that two cells have their respective TDD DL/UL configurations different from each other, cells more than two may be configured and they may have their respective TDD DL/UL configurations different from one another.

According to the aforementioned embodiment of the present invention, transmission timing delay of control information (for example, HARQ feedback), which may occur when the cells have their respective TDD DL/UL configurations different from each other, may be avoided, whereby communication throughput may be improved.

The aforementioned embodiments are achieved by combination of structural elements and features of the present invention in a predetermined type. Each of the structural elements or features should be considered selectively unless specified separately. Each of the structural elements or features may be carried out without being combined with other structural elements or features. Also, some structural elements and/or features may be combined with one another to constitute the embodiments of the present invention. The order of operations described in the embodiments of the present invention may be changed. Some structural elements or features of one embodiment may be included in another embodiment, or may be replaced with corresponding structural elements or features of another embodiment. Moreover, it will be apparent that some claims referring to specific claims may be combined with another claims referring to the other claims other than the specific claims to constitute the embodiment or add new claims by means of amendment after the application is filed.

It will be apparent to those skilled in the art that the present invention can be embodied in other specific forms without departing from the spirit and essential characteristics of the invention. Thus, the above embodiments are to be considered in all respects as illustrative and not restrictive. The scope of the invention should be determined by reasonable interpretation of the appended claims and all change which comes within the equivalent scope of the invention are included in the scope of the invention.

### INDUSTRIAL APPLICABILITY

The method for enabling a user equipment to transmit uplink control information in a wireless communication system may be used industrially in various communication systems such as 3GPP LTE or LTE-A system.

1. A method for transmitting uplink control information by a user equipment in a wireless communication system, the method comprising the steps of:
receiving, from a base station, information on a primary cell (Pcell) and at least one secondary cell (Scell) configured for the user equipment; and
transmitting the uplink control information through a specific Scell configured for the user equipment when the Pcell and the Scell have their respective time division duplex (TDD) downlink (DL)/uplink (UL) configurations different from each other and the user equipment is configured to simultaneously transmit a physical uplink control channel (PUCCH) and a physical uplink shared channel (PUSCH).

2. The method according to claim 1, wherein the uplink control information is at least one of hybrid automatic repeat request (HARQ) feedback information, periodic channel state information (CSI) reporting information, channel quality information (CQI), precoding matrix index (PMI) information, rank indicator (RI) information, or scheduling request (SR) information.

3. The method according to claim 1, wherein the HARQ feedback information is for a physical downlink shared channel (PDSCH) of the specific Scell configured for the user equipment.

4. The method according to claim 1, wherein an interval to which the uplink control information is transmitted is allocated as a downlink subframe for the Pcell and as an uplink subframe for the specific Scell configured for the user equipment.

5. The method according to claim 1, wherein the specific Scell is any one Scell allocated to the interval to which the uplink control information will be transmitted, as the uplink subframe interval, if a plurality of Scells are configured for the user equipment.

6. The method according to claim 1, wherein the specific cell is the Scell to which the PUSCH is transmitted together with the uplink control information (UCI) when a plurality of Scells are configured for the user equipment and the uplink subframe interval for all of the plurality of the Scells is allocated to the interval to which the uplink control information will be transmitted.

7. A user equipment for transmitting uplink control information in a wireless communication system, the user equipment comprising:
a receiver configured to receive, from a base station, information on a primary cell (Pcell) and at least one secondary cell (Scell) configured for the user equipment;
a processor configured to perform a control operation to transmit the uplink control information through a specific Scell configured for the user equipment when the Pcell and the Scell have their respective time division duplex (TDD) downlink (DL)/uplink (UL) configurations different from each other and the user equipment is configured to simultaneously transmit a physical uplink control channel (PUCCH) and a physical uplink shared channel (PUSCH); and
a transmitter configured to transmit the uplink control information through the specific Scell configured for the user equipment.

8. The user equipment according to claim 7, wherein the uplink control information is at least one of hybrid automatic repeat request (HARQ) feedback information, periodic channel state information (CSI) reporting information, channel quality information (CQI), precoding matrix index (PMI) information, rank indicator (RI) information, and scheduling request (SR) information.

9. The user equipment according to claim 8, wherein the HARQ feedback information is for a physical downlink shared channel (PDSCH) of the specific Scell configured for the user equipment.

10. The user equipment according to claim 8, wherein an interval to which the uplink control information is transmitted is allocated as a downlink subframe for the Pcell and as an uplink subframe for the specific Scell configured for the user equipment.

11. The user equipment according to claim 8, wherein the specific Scell is any one Scell allocated to the interval to which the uplink control information will be transmitted, as the uplink subframe interval, if a plurality of Scells are configured for the user equipment.

12. The user equipment according to claim 8, wherein the specific cell is the Scell to which the PUSCH is transmitted together with the uplink control information when a plurality of Scells are configured for the user equipment and the uplink subframe interval for all of the plurality of the Scells is allocated to the interval to which the uplink control information will be transmitted.
